(19) United States
(12) Patent Application Publication
(10) Pub. No.: US 2008/0288371 A1
(43) Pub. Date: Nov. 20, 2008

(54) Internet based method and process for facilitating the presentation, sale, purchase, development and management of creative ideas concepts and content

(76) Inventor: Klaus Holzapfel, Westminster, CO (US)

Correspondence Address: Klaus Holzapfel, 10230 Zenobia Cir, Westminster, CO, 80031, US

(21) Appl. No.: 12/104,451

(22) Filed: Apr. 17, 2008

Related U.S. Application Data
(60) Provisional application No. 60/938,744, filed on May 18, 2007.

(51) Int. Cl. G06Q 30/00; G06Q 20/00; H04L 9/32; G06F 7/06; G06F 17/30

(52) U.S. Cl. 705/27; 726/7; 707/6; 707/E17.005; 707/E17.017

(57) ABSTRACT

The present invention provides a internet based method and process for facilitating the submission, presentation, sale, purchase, development, and management of creative ideas, concepts and or content that generally comprises computer software, including internet web page based code, and methods of applications for providing clients, or creative contents buyers and creative content providers, more particularly with an internet based website that serves as an interface between clients looking for creative content and providers of creative content including but not limited in use to, video artists, photographers, writers, musicians, graphic artists, animators, etc., and which will serve as a development and or production management platform for the content contained therein.

### FIELD OF THE INVENTION

The present invention relates generally to a business method, computer system and software implemented method in the field of internet based communication that provides for secure and high speed transmission of media files across a telephone, internet, intranet, satellite, cable or combination network. More particularly the present invention is directed to an internet based website for facilitating the storage, presentation, sale, purchase, development, & management of creative ideas, concepts, and or content, namely, graphics, images, streaming media files, software, and other digital objects. This method permits peer to peer transmission of creative ideas, concepts, and or content without piracy of the same.

### BACKGROUND OF THE INVENTION

As is known, the Internet typically refers to a number of data service systems connected together via a high speed interconnect network. Each data service system typically includes web or other content servers that host contents for various customers. The servers can also host applications. Each of the data service systems is typically implemented by a computer system (e.g., a server computer system). A number of remote user terminals may be connected to a data service system via an interconnect network (e.g., a telephone network). The remote user terminals are typically referred to as clients. This arrangement allows users at the user terminals to access the contents, services, and/or applications hosted in various data service systems. Each user terminal is equipped with a web browser that allows the user terminal to access the contents, services, and/or applications hosted in various data service systems.

More and more entities now have their own web sites and/or web pages. When a user accesses that site, the user can get news announcement, product information, and contact information, etc. The user may also be permitted to purchase products via that site. The user can also move to other pages to get even more information and/or service. In addition to this, a wide variety of new Internet-based media delivery platforms have also been developed. One reason the internet has become very popular is that it makes content access extremely easy. The Internet is popular for downloading and sharing content such as music files, movies, and the like. People want to share files over the internet. Whether the files are simple web pages, audio clips such as MP3's, photographs, or other content, the preferred means for sharing files is via the web.

However, the rapid growth of the Internet and widespread use of Web (WWW) have made it very difficult for Internet users to effectively and efficiently manage contents of their choice or preference. The Internet users also find it difficult to identify contents of their choice. As of today, there does not exist a mechanism that helps Internet users manage contents of their preferences. There is no existing mechanism on the internet that help the owners of creative content to effectively store, present, sell, & manage their creative ideas, concepts, and or content. Similarly there is no existing mechanism on the internet that allows potential buyers of such creative content to purchase the same. There also exists no existing mechanism on the internet that allows the owner of creative content and potential buyers of such content to link with each other through innovative matching techniques or that facilitate open source advertising.

Again, people desiring to download and share content for their personal use are limited to few options other than paying for downloads over a fee-based service. This has the drawback that it actually cost the consumer money, which is undesirable for many consumers. Again while the web makes accessing content simple, as almost anyone can use a browser, publishing content on a computer network like the web is more expensive and difficult. Similarly prior efforts to solve this problem suffer from certain disadvantages; they are special purpose software must be installed and availability is limited when a user's own computer, which acts as a server, is turned off or is isolated by network outages, and firewalled users, or other users who cannot accept inbound connections, can't publish content from their own computers and fee-based web hosting companies charge substantial fees for service and storage, yet free web hosting systems impose restrictive storage quotas or rely on repulsive advertising to help defray their costs.

Further illegal digital file sharing and pirating of digital content have increasingly become a problem on the internet or on other communication networks.

Moreover, current file-sharing methods over the internet do not provide an efficient way to transfer media use fees from end user to persons that might be interested in paying media royalty or user fees on the behalf of certain end users. Encryption methods for transmitted data have traditionally slowed the transmission of data to a point that end users do not want to use such systems or need to have a special and expensive translation unit provided by the media producer.

Therefore there is a need for an internet based website that allows content storage, purchase and management without any of the above drawbacks.

The relevant prior art methods, which will deal with camera with light source which uses a recording device, are as follows:

US Patent Application No. 20070125620 discloses methods and systems for exchanging various forms of value, including coins, paper currency, credit, and/or debit, for Internet service and digital content. Such digital content can include, for example, online games and content for mobile phones. In one embodiment, a value exchange machine includes a coin input region, a coin sorting/counting apparatus, a card reader, and a communications facility configured to communicate with a remote computer network. A user wishing to purchase Internet service, for example, can visit the value exchange machine, select the desired transaction, and pay for the Internet service with coins, paper currency, a credit card, a debit card, and/or bank account funds. After confirming payment, the value exchange machine can issue a code to the user, for example, on a card enabling the user to obtain the Internet service.

US Patent Application No. 20060041830 claims a method and apparatus for gathering, organizing and disseminating web-based content to others, optionally with the association and display of dynamic metadata. The invention enables the operator to select the URL addresses of data accessible via the internet and group them together into a collection that is stored in a database on a central server that can then be disseminated to others via hyperlink. Metadata such as messages are stored on the central server and can been associated with each member of the collection and can be updated dynamically by the recipients. The hyperlink launches a web browser that retrieves the URL collection and metadata from the server and presents it to the recipient in a navigable apparatus. The invention enables digital media performances to be a nexus for associating and accessing the hyperlinks to launch said collections and for associating additional metadata.

US Patent Application No. 20050210379 details a method and system for providing automated web publishing using templates and use of third party network sites to dynamically communicate information to a hosting application and to receive custom content based on a call to the hosting application for publishing the content at a publishing location relevant to the content. The system includes three tiers of architecture, including 1) presentation logic to capture, organize, and publish content at the third party site and to provide for administration of the site; 2) business logic for handling information requests via a server on the network providing information to the third party site; and 3) persistent storage using, for example, relational databases or other repositories to support functionality.

US Patent Application No. 20050198317 discloses a method for sharing content over a network. According to the method, pluralities of requests for receiving content are received by a server from user terminals. And, announcements of content or playlists that are to be broadcast are received from broadcast devices. The requests for content are analyzed to determine if the desired content is scheduled to be broadcast, as indicated in an announcement or playlist from a broadcast device. If the desired content is scheduled to be broadcast, then the user terminal is notified, and a recording of the broadcast is preferably, automatically arranged at the user terminal. The desired content is recorded with leading and trailing advertisements. Hence, to perceive the content, the advertisements must be perceived.

US Patent Application No. 20030005077 describes a personalized content server system that includes a profile module that receives a profile file specifying personal preferences of a user for some content. An access module accesses remote content servers external to the personalized content server system for the content specified by the profile file. A content storage stores the content such that the content can be retrieved from the content storage when the user accesses the personalized content server system for the content via an access client.

US Patent Application No. 20020147774 claims a method for content storage on behalf of participating content providers begins by having a given content provider identify content for storage. The content provider then uploads the content to a given storage site selected from a set of storage sites. Following upload, the content is replicated from the given storage site to at least one other storage site in the set. Upon request from a given entity, a given storage site from which the given entity may retrieve the content is then identified. The content is then downloaded from the identified given storage site to the given entity. In an illustrative embodiment, the given entity is an edge server of a content delivery network (CDN).

US Patent Application No. 20020103830 provides improved methods for controlling the presentation of multimedia content on a web page. Such methods include detecting the occurrence of a particular event or a combination of events with respect to a web page. An event trigger indicative of the detected event or combination of events is generated. This event trigger is used to select a multimedia player and the multimedia content to be played by the selected player. The selected multimedia player is loaded with the selected content and the playing of the selected player is launched to provide a desired multimedia presentation on the web page.

US Patent Application No. 20080005027 claims the use of a proprietary encryption technique for digital media files, a proprietary reassembly process for digital media files and unique user keys, wherein the access to a digital media file or portion thereof is controlled by the digital media rights of the key or digital media access card, which access may be constrained to a particular machine, a particular user, a particular period of time, or a combination thereof. This method permits peer to peer transmission of information without piracy of the media, such that access can be paid for by a third party or can be paid for by end user, and digital media rights licenses may optionally provide for a transfer of digital media rights for a particular digital media file.

US Patent Application No: 20030120680 discloses a system, method, and business method for operating a computer as a server for directly providing content and services via a computer network, by assigning a URL to the computer, associating at least one directory in a storage device with the URL, directing access requests from said URL to the directory, and delivering requested content and services, potentially for revenue. The content may be dynamic and contained in a database. The services may include storing data. The directory may be replicated onto additional computers to which access requests may be directed. Access requests may be authenticated as coming from members of a peer group having access rights. The invention features a one-click process for publishing content to an intranet or the internet, and employs known file transfer protocols.

However the purpose and methodology of the above inventions that are part of prior art do not envisage an improved internet based website that allows content owners and buyers to store, present, sell, purchase, develop, & manage creative ideas, concepts, and or content and link to each other through innovative matching techniques.

In view of the limitations now present in the prior art, the present invention provides a new and useful internet based method and process for facilitating the presentation, sale, purchase, development, and management of creative ideas, concepts, and or content, which is simpler in application, high costs, or risk of content piracy, or risk of inefficient file transfer more universally usable and more versatile in operation than known applications of this kind.

It will be apparent to those skilled in the art that the objects of this invention have been achieved by providing an internet based method and process which is unique in nature unlike existing models. Various changes may be made in and without departing from the concept of the invention. Further, features of some stages disclosed in this application may be employed with features of other stages. Therefore, the scope of the invention is to be determined by the terminology of the following descriptions, claims, drawings and the legal equivalents thereof.

### SUMMARY OF THE INVENTION

This invention may be summarized, at least in part, with reference to its objects. Accordingly several advantages and objects of the present invention are as follows:

A principal objective of the present invention is to provide an internet based method and process for facilitating the presentation, sale, purchase, development, & management of creative ideas, concepts, and or content that will overcome the deficiencies of the prior art content submittal applications.

Another objective of the present invention is to provide an internet based method and process that will allow a creative content provider to upload and present ideas, concepts, or content.

Another objective of the present invention is to provide an internet based method and process that will allow a creative content provider to manage and check status of uploaded and pending submissions.

Another objective of the present invention is to provide an internet based method and process that provides clients or customers with a database of content to select from.

Yet another objective of the present invention is to provide an internet based method and process that provides clients or customers with a database of creative content providers to commission for the creation of project specific content.

Yet another objective of the present invention is to provide an internet based method and process that manages the development and or production of the content contained therein.

Yet another objective of the present invention is to provide an internet based method and process which utilizes web based icons to notify a creative content provider of the various stages of status pertaining to content submissions.

A further objective of the present invention is to provide an internet based method and process that utilizes filtering methods to match creative content providers with client projects.

A further objective of the present invention is to provide an internet based method and process that can be utilized with a variety of different types of media content.

A further objective of the present invention is to provide an internet based method and process that can be utilized for open source advertising

It is intended that any other advantages and objects of the present invention that become apparent or obvious from the detailed description or illustrations contained herein are within the scope of the present invention. Thus the above and other objects of the present invention will be more readily apparent when considered in reference to the following description and when taken in conjunction with the accompanying drawings.

### DESCRIPTION OF THE INVENTION

The following description is presented to enable any person skilled in the art to make and use the invention, and is provided in the context of particular applications of the invention and their requirements. The present invention can be configured as follows:

The purpose of the present invention is to provide a new internet based website for facilitating the presentation, sale, purchase, development, & management of creative ideas, concepts, and or content which will allow a user to present creative ideas, concepts, or content, for potential production and distribution of creative ideas, concepts, and or content. It is also a purpose of the present invention to provide a new internet based method and process for facilitating the presentation, sale, purchase, development, & management of creative ideas, concepts, and or content that has many novel features not offered by the prior art applications and which is not apparent, obvious, or suggested, either directly or indirectly by any of the prior art applications.

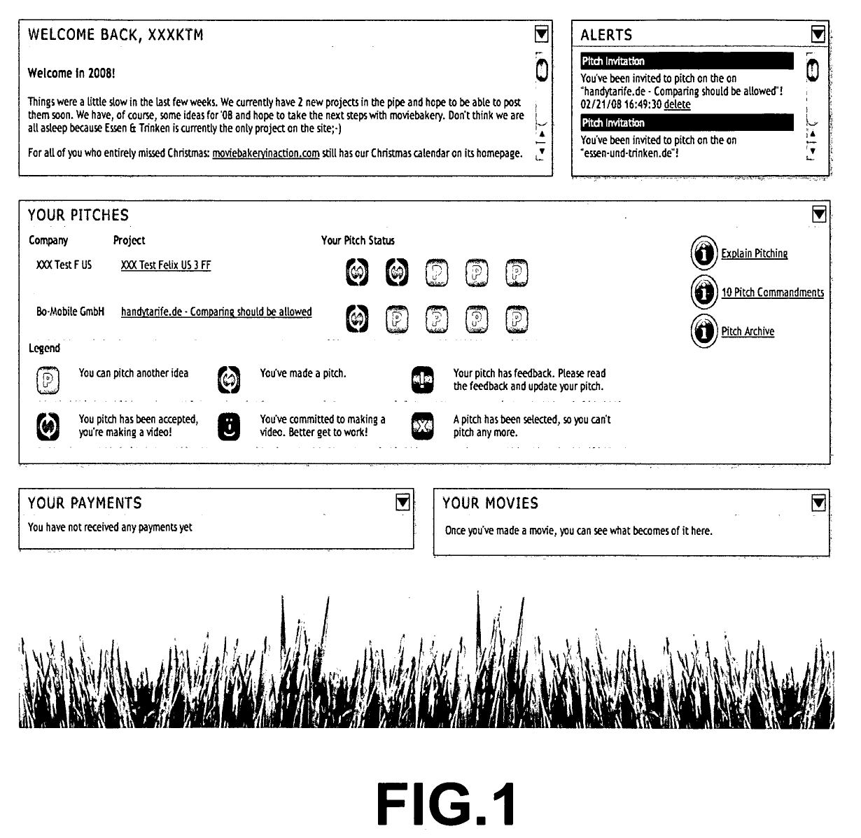

FIG. 1 is a screen grab image of website enabled by present invention, illustrating the homepage with 3 pitches submitted

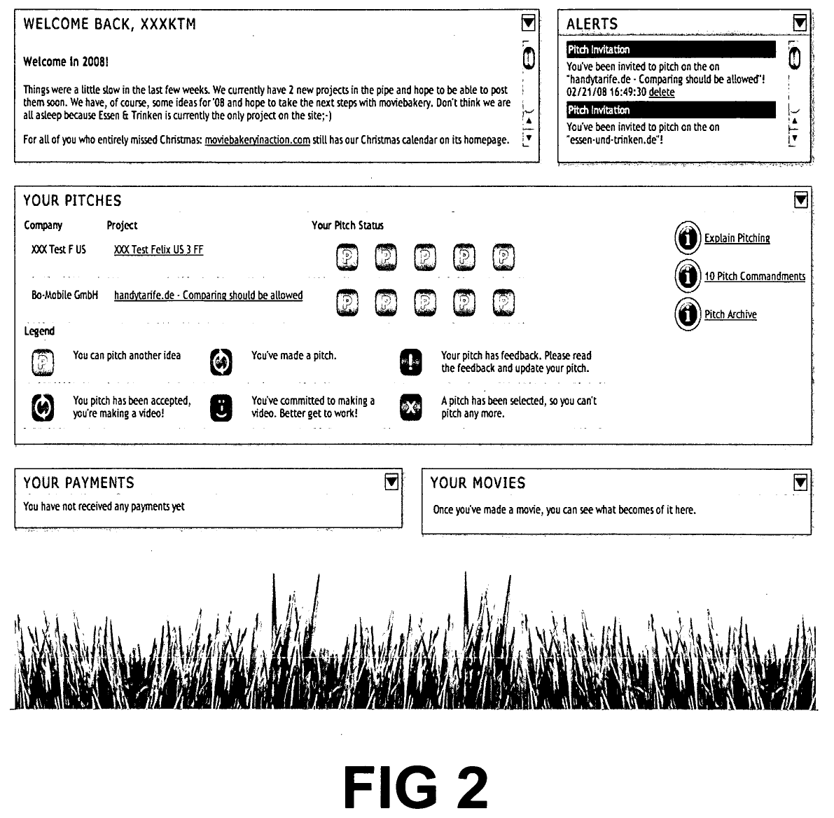

FIG. 2 is a screen grab image of website enabled by present invention, illustrating the pitch screen final

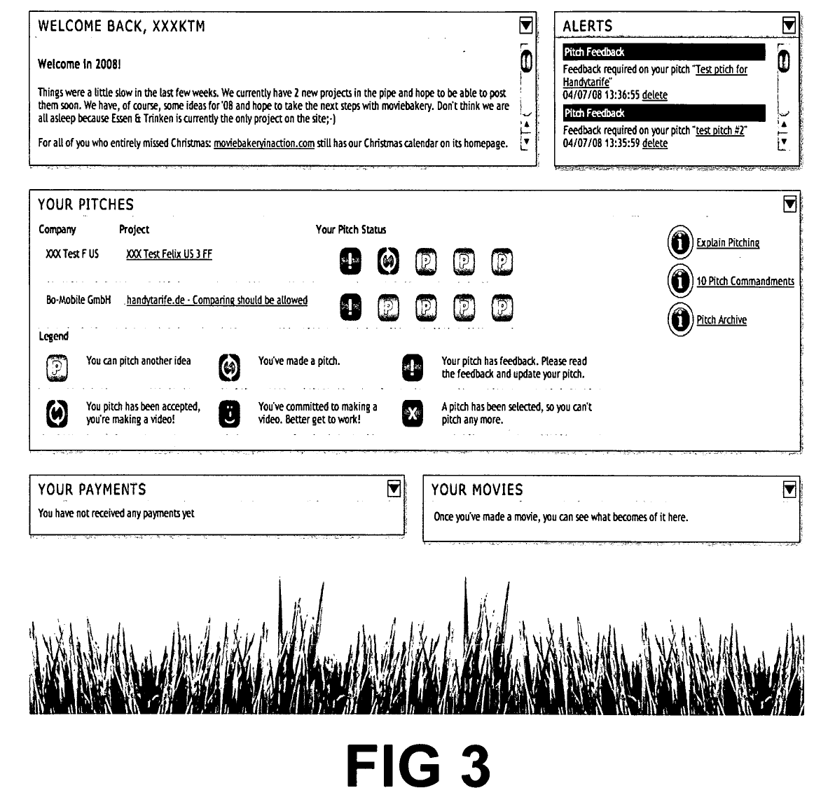

FIG. 3 is a screen grab image of website enabled by present invention, illustrating admin feedback

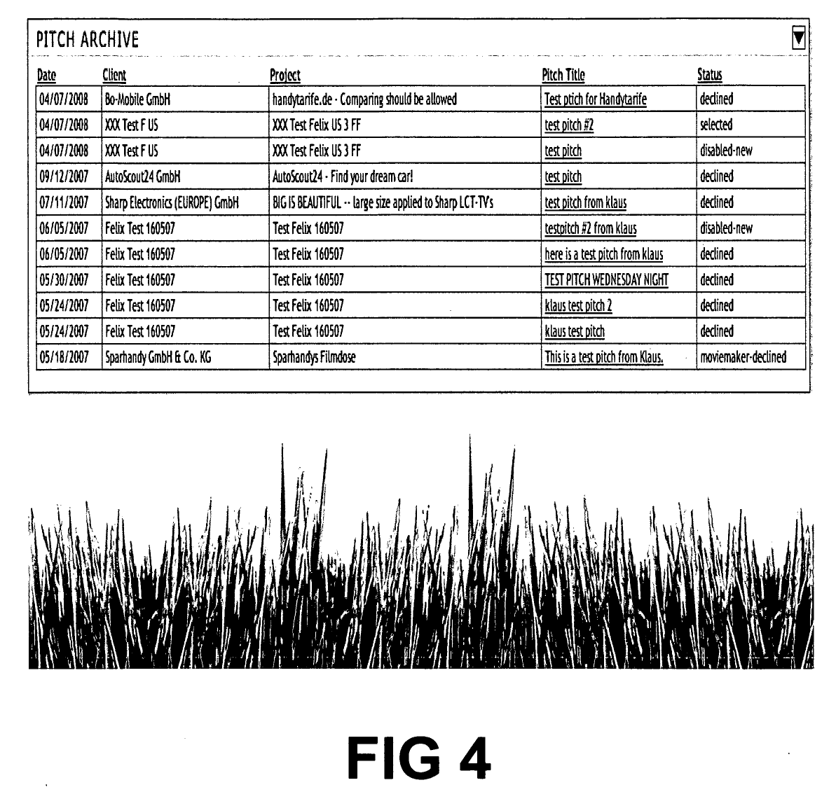

FIG. 4 is a screen grab image of website enabled by present invention, illustrating pitch archive

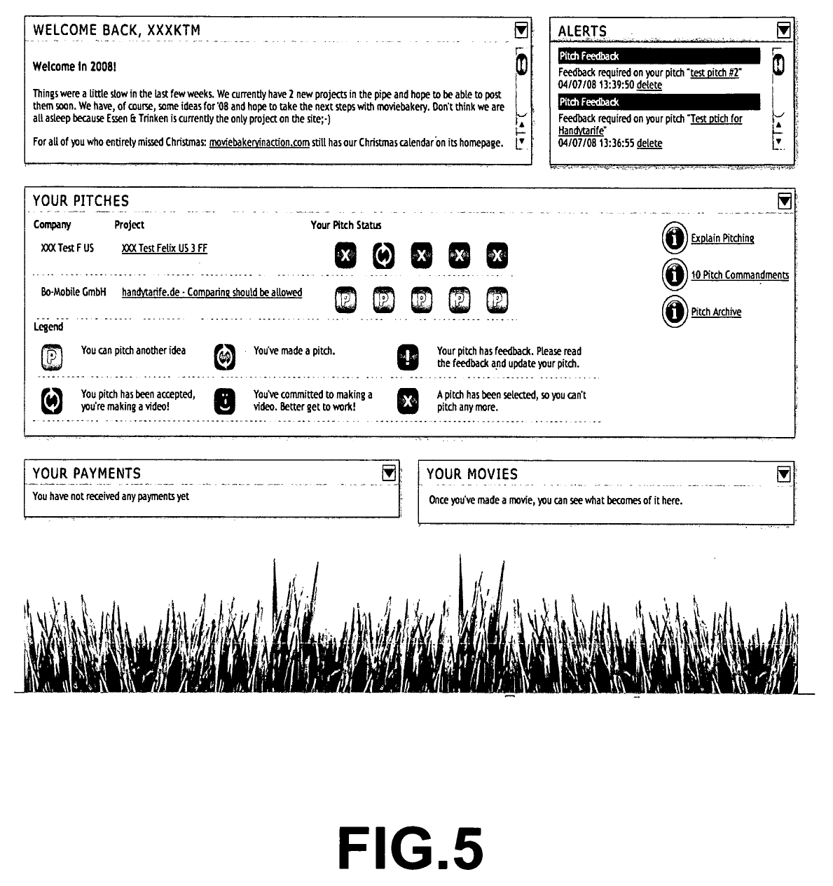

FIG. 5 is a screen grab image of website enabled by present invention, illustrating pitch selected

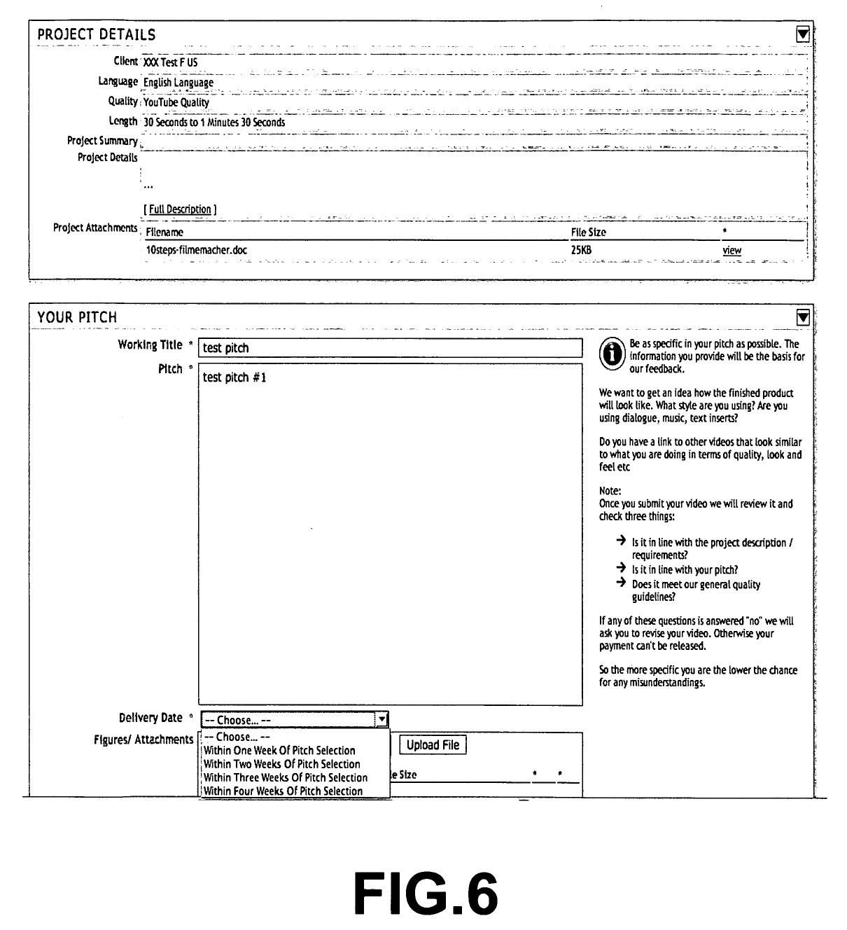

FIG. 6 is a screen grab image of website enabled by present invention, illustrating pitching page

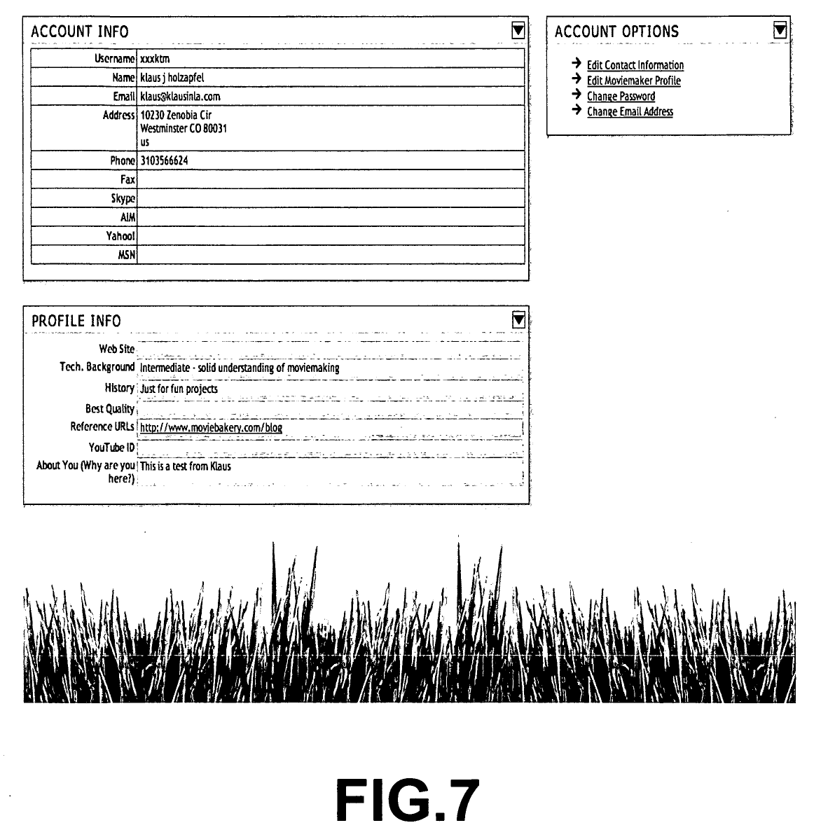

FIG. 7 is a screen grab image of website enabled by present invention, illustrating profile page

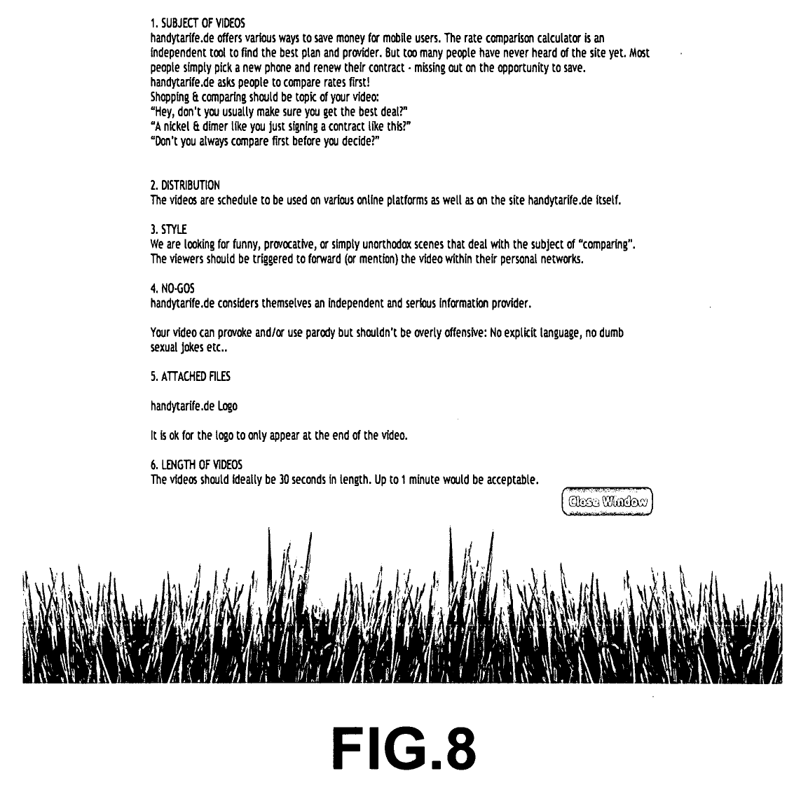

FIG. 8 is a screen grab image of website enabled by present invention, illustrating project description detailed view page

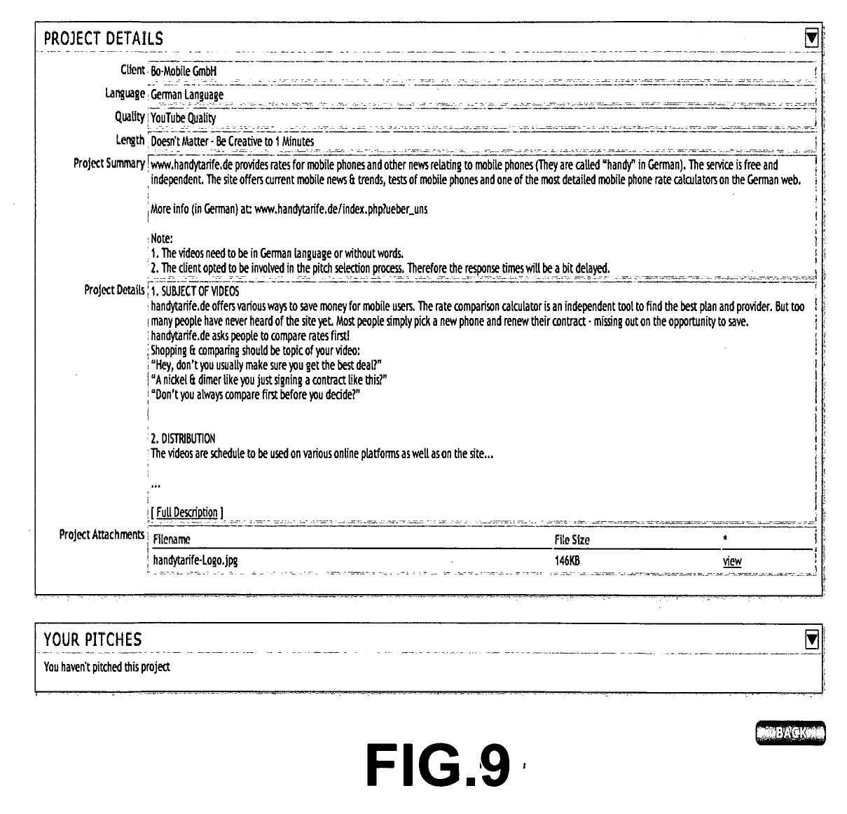

FIG. 9 is a screen grab image of website enabled by present invention, illustrating project summary page

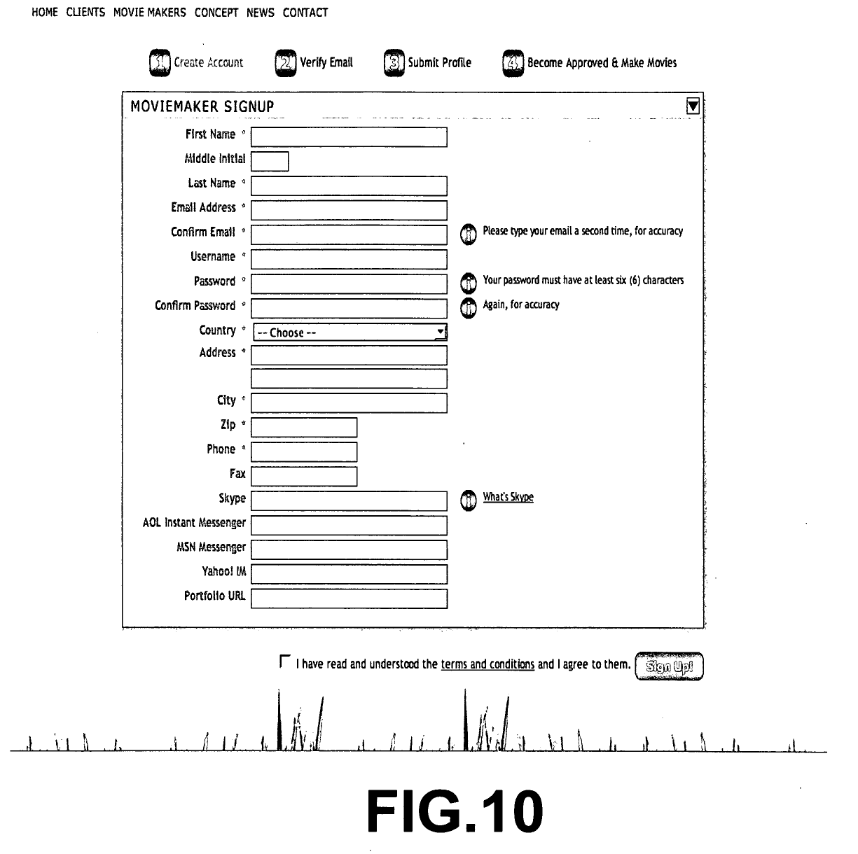

FIG. 10 is a screen grab image of website enabled by present invention, illustrating project signup page

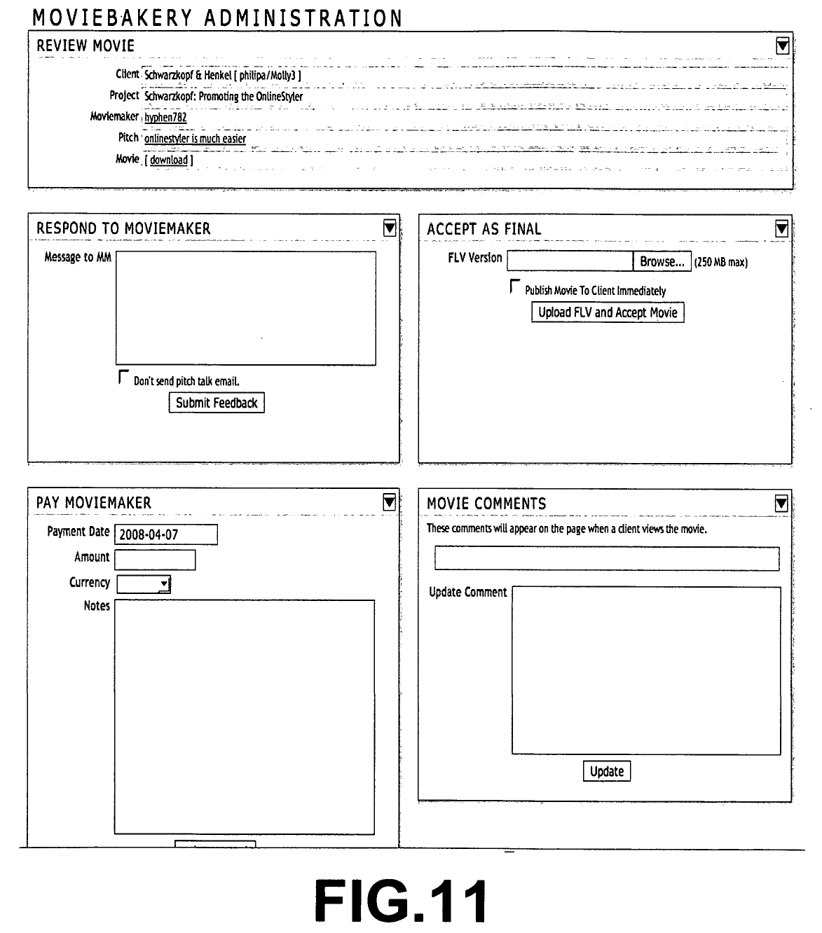

FIG. 11 is a screen grab image of website enabled by present invention, illustrating manage videos page

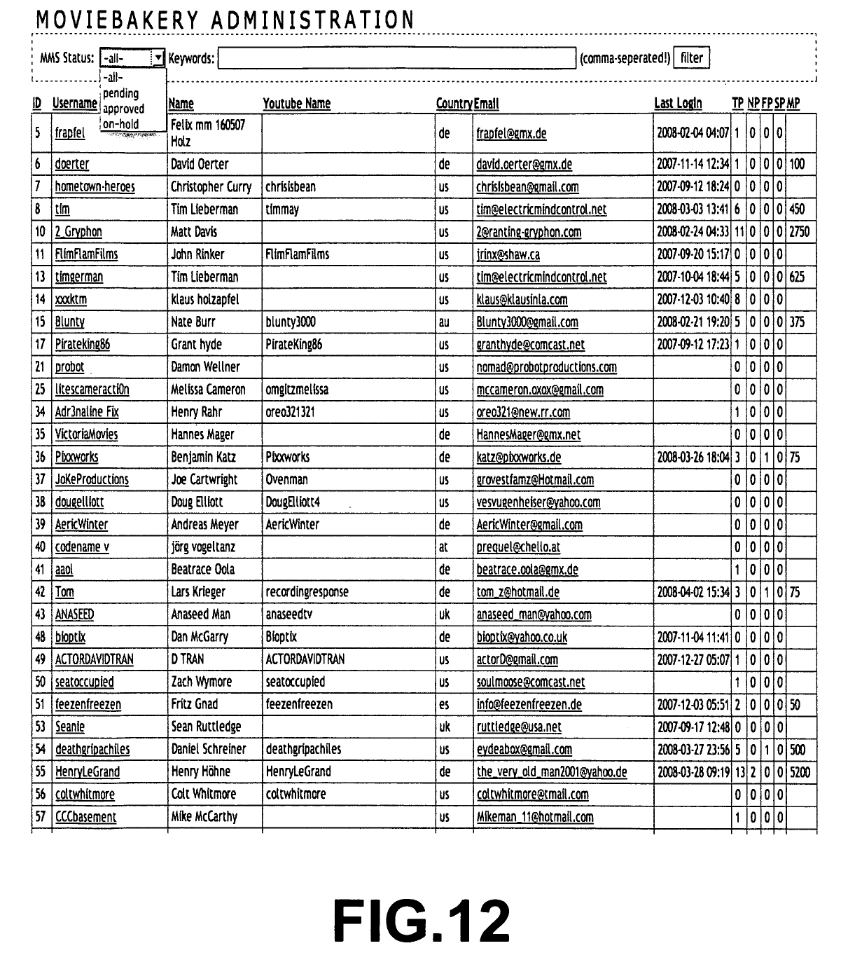

FIG. 12 is a screen grab image of website enabled by present invention, illustrating mm overview page

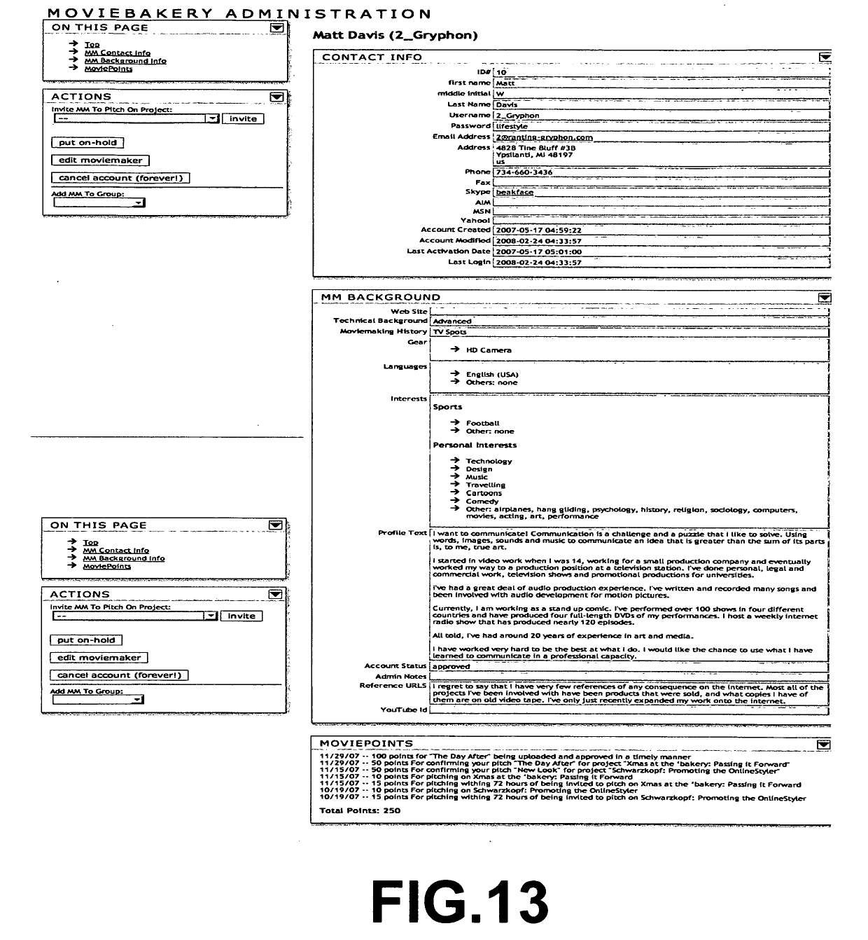

FIG. 13 is a screen grab image of website enabled by present invention, illustrating mm profile page

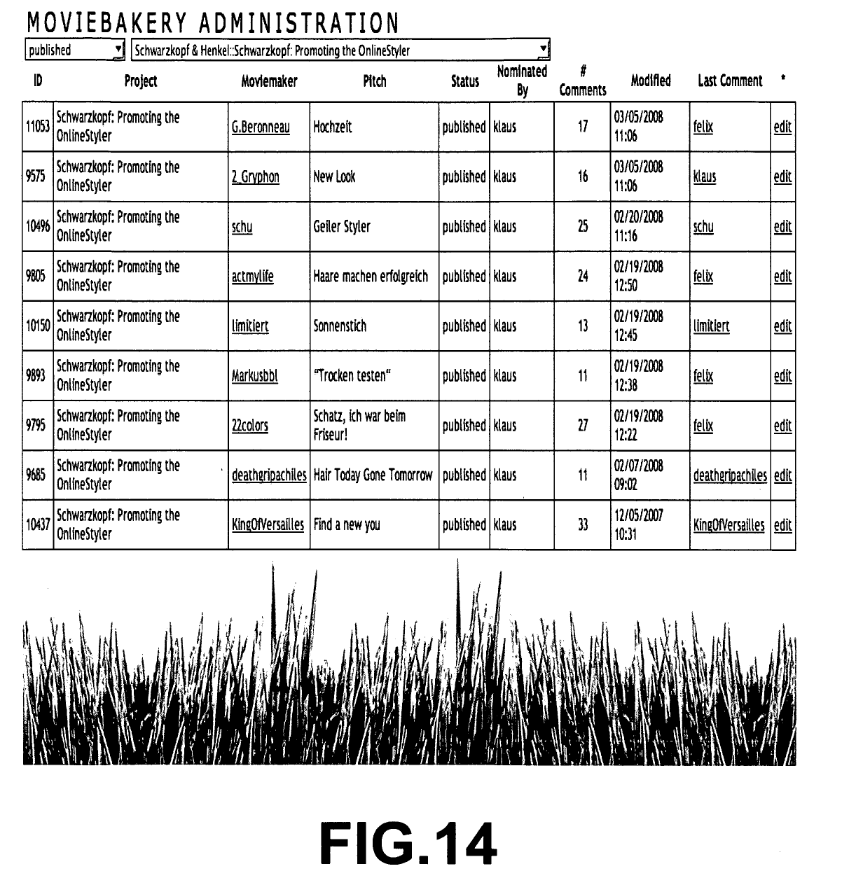

FIG. 14 is a screen grab image of website enabled by present invention, illustrating movies published page

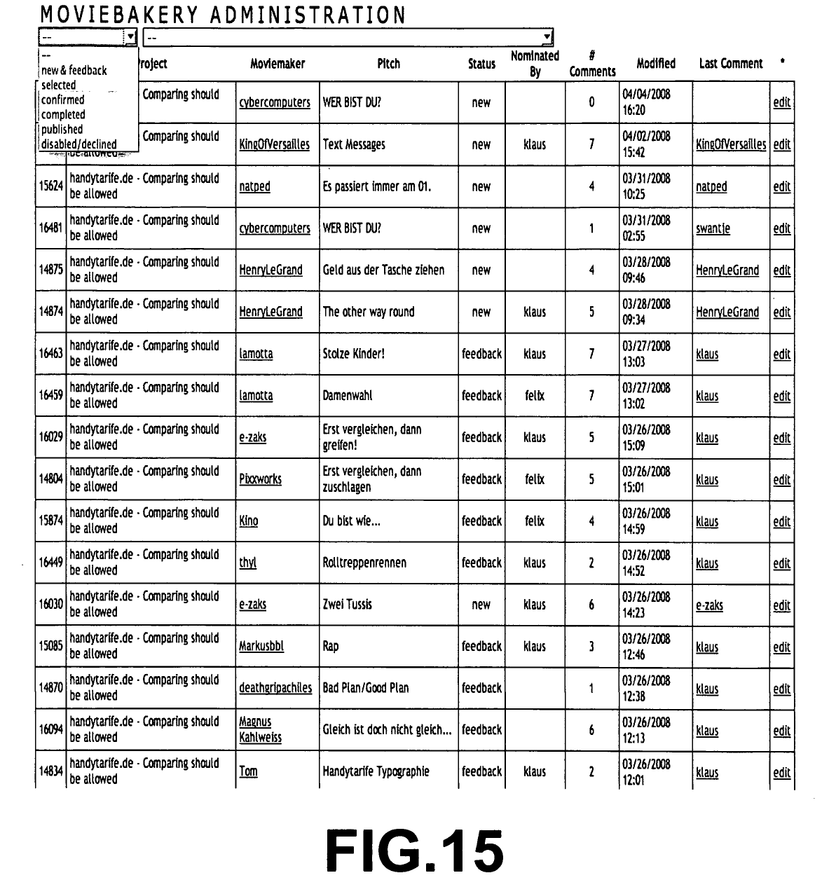

FIG. 15 is a screen grab image of website enabled by present invention, illustrating pitches overview options

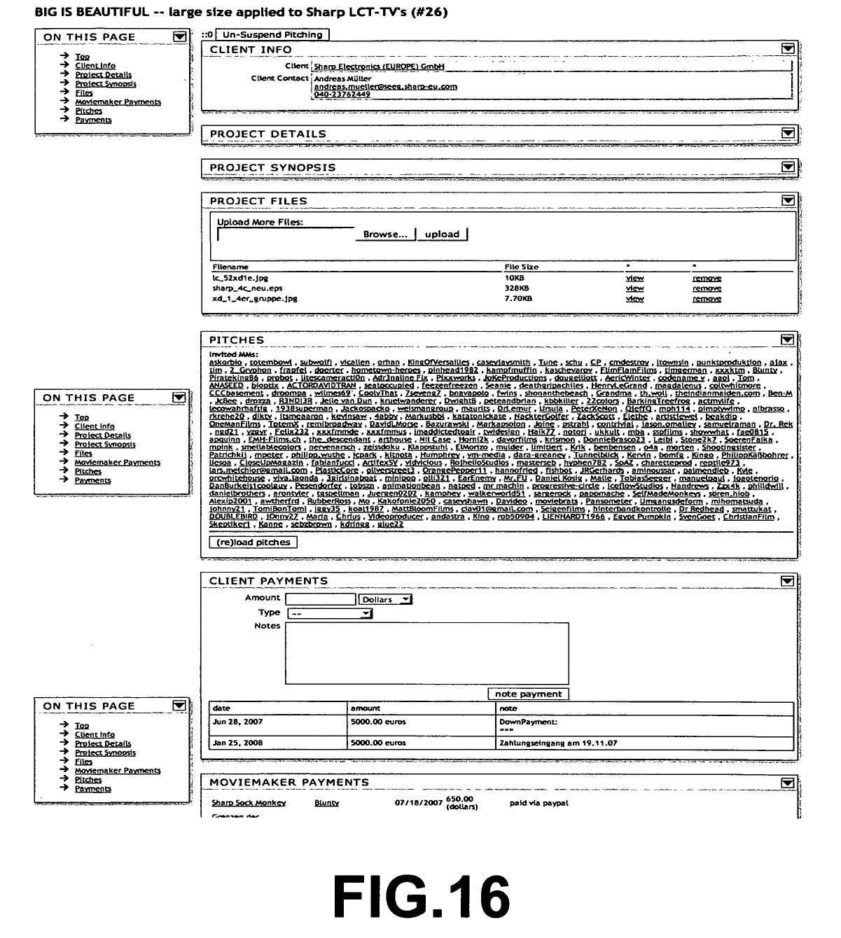

FIG. 16 is a screen grab image of website enabled by present invention, illustrating project page

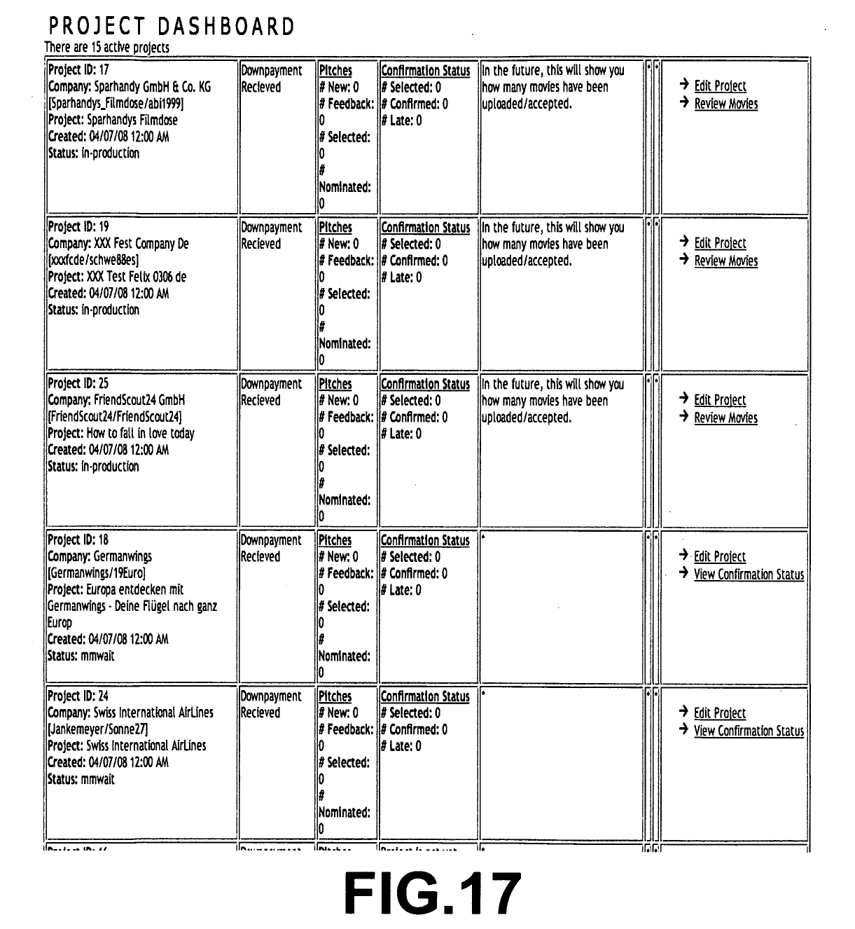

FIG. 17 is a screen grab image of website enabled by present invention, illustrating project summary page

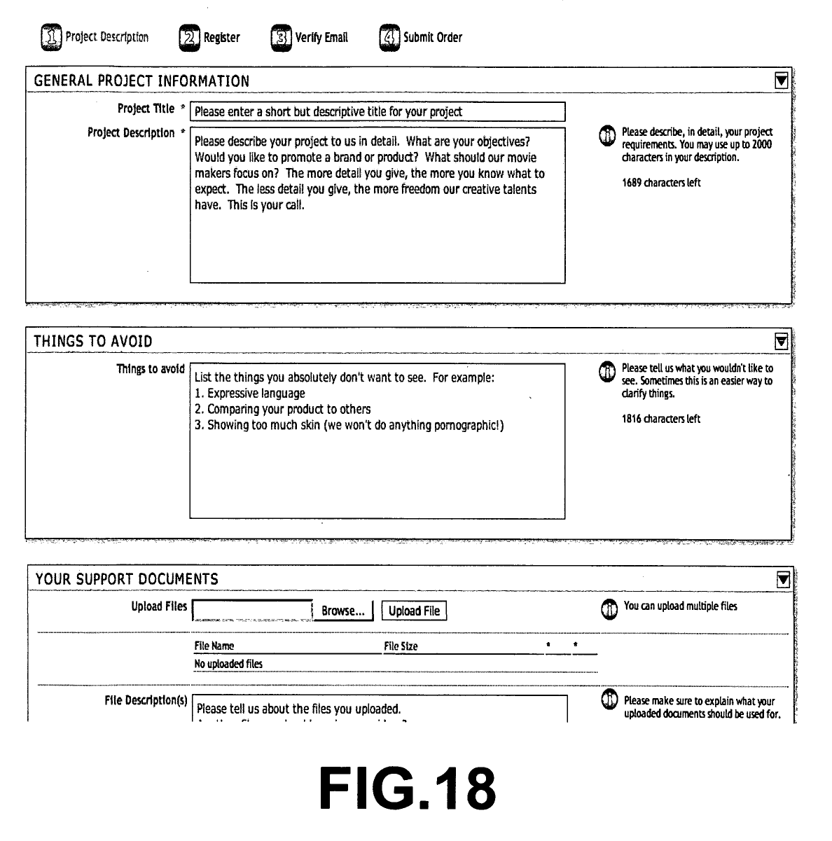

FIG. 18 is a screen grab image of website enabled by present invention, illustrating dummy project page

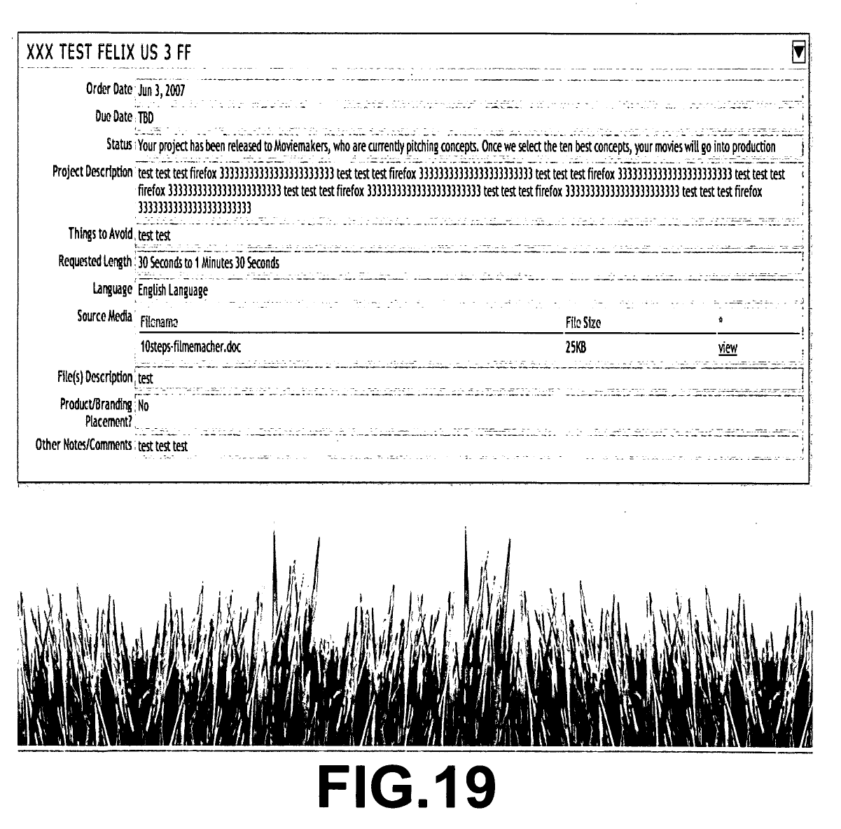

FIG. 19 is a screen grab image of website enabled by present invention, illustrating order videos page

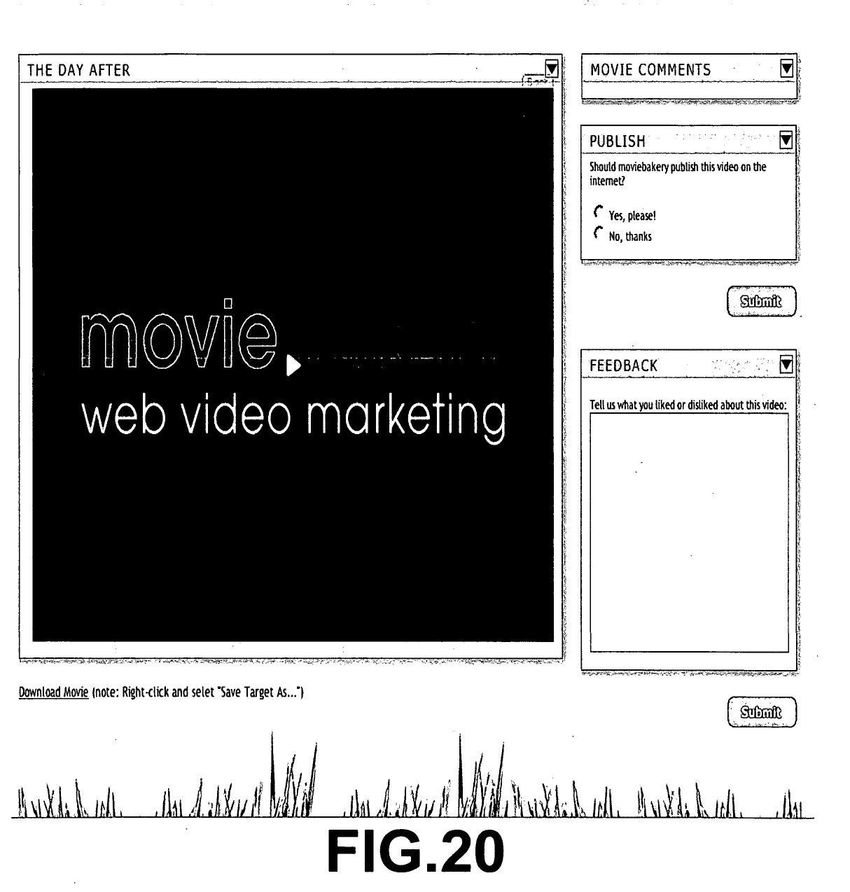

FIG. 20 is a screen grab image of website enabled by present invention, illustrating videos feedback page

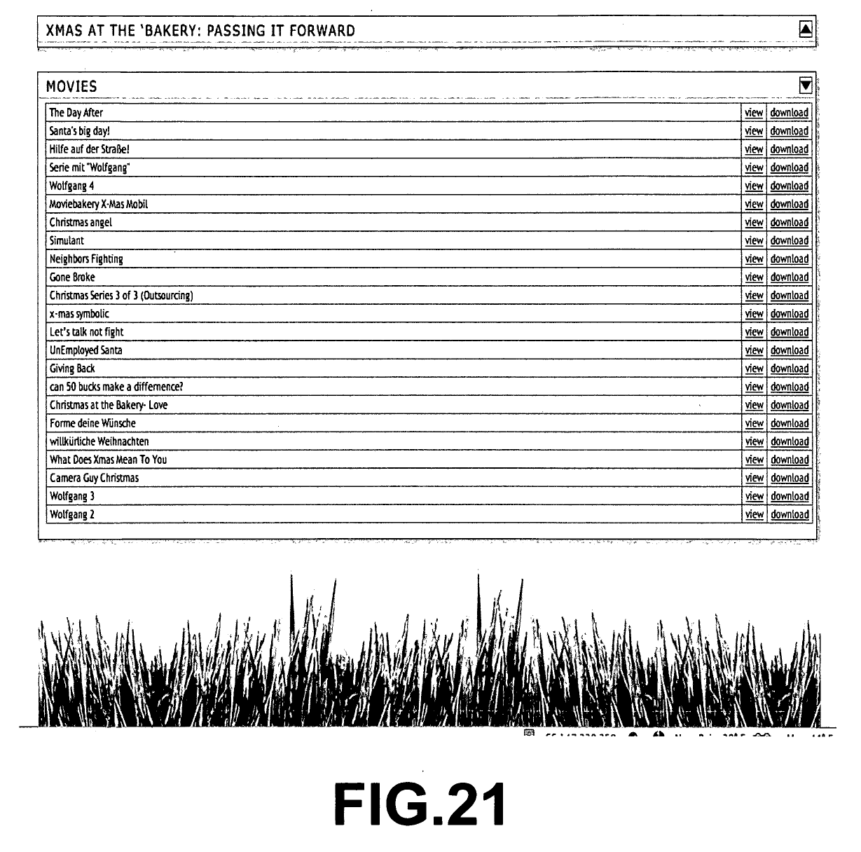

FIG. 21 is a screen grab image of website enabled by present invention, illustrating videos received page

The present invention in the preferred embodiment generally comprises computer software, including internet web page based code, and methods of applications for providing clients, or creative content buyers and creative content providers with an internet based website that serves as an interface between buyers looking for creative content and providers of creative content including but not limited in use to, video artists, photographers, writers, musicians, graphic artists, animators, etc.

In the preferred embodiment, a creative content provider will access the main service website where they will then be prompted to enter log-in information in the form of a user name and or password or other secure login method not referred to herein which performs the same function. Upon entering the log-in information and successful authentication, the creative content provider will be able to utilize the website as a platform for submitting their creative idea, concept, or content to the main website administrator who will interactively review and evaluate the submission, and thereby either accept or reject the submission. During the review and evaluation process, the website administrator may give feedback, suggestions, or other assistance to the creative content provider pertaining to the submission. The submission management interface region of the website will allow a creative content provider to easily login and check the status of one or a multitude of pending submissions, otherwise referred to herein as “pitches”. This feature allows the creative content provider to see at one snapshot what the status of any of his/her ideas is, including but not limited in use to, “empty” (no idea submitted yet), “pending review”, “review with feedback”, “rejected” or “accepted”.

The present invention will include one or a multitude of computer code based filters that will act to match creative content provider submissions with content buyer projects that have been submitted as content request submissions. The filters may utilize, keyword match, content match, content type, content buyer project code numbers or other project specific identifiers, or other idea, concept, or content data or parameters not referred to herein which will assist in matching content provider submissions with content buyer projects.

The present invention provides an extensive database of creative ideas, concepts, and or content for a content buyer to choose from, as well as a database of creative content providers that can be presented with or offered a project having specific criteria, guidelines, and or parameters in regards to appearance, design, function, and or content, whereby new creative content submissions may be initiated through the main service website, directed towards or created for, a specific project or content buyer content request submission.

The present invention in the preferred embodiment disclosed herein will further allow a content buyer to access the main service website where they will then be prompted to enter log-in information in the form of a user name and or password or other secure login method not referred to herein which performs the same function. Upon entering the log-in information and successful authentication, the content buyer will be able to utilize the website to perform a variety of functions or actions including but not limited in use to, input one or a multitude of new potential projects or content request submission into the database, manage existing potential projects or content request submissions, and or search through the database of submitted creative ideas, concepts, or content manually. If a submission is identified that meets the criteria or parameters of a specific client project, then the client can select that submission for further development or production through the main website.

It is to be understood that the present invention in the preferred embodiment is a web based application written in PHP, my SQL using AJAX. It is also to be understood that other platforms, systems, languages, or coding methods may be utilized to create or make additions to the main website that performs the same function and are therefore to be considered apparent and obvious to the disclosure contained herein.

A creative content provider that qualifies for a certain project has the opportunity to pitch his/her ideas with our “creative idea development & management tool”. The website disclosed herein will provide creative content providers with a marketplace to shop their ideas, concepts, or content in a project specific or non project specific manner. It will connect them with clients or creative content buyers who are seeking to purchase ideas, concepts, and or content for development and production. Main benefits for content providers from the present invention will include snapshots of all project and their status on one single page and systematic way of receiving feedback/approval of submitted ideas. Main benefits for content buyers from the present invention will include access to a huge talent base of creative clients, getting provided with ideas that would never come up otherwise and cost effectiveness because it is fully automated.

The present invention also facilitates open source advertising.

The website disclosed herein will allow a creative content provider to earn revenue or monies on a per submission basis if the submission of selected for further development and or production. The website will also receive revenues or monies from clients who hire or otherwise commission the website to locate, match, or otherwise provide creative content for a specific project request submission.

A number of ways exist to generate revenue from this business model.

1. Clients can pay a fee on a per project basis.

2. Clients can pay a fee on a per submission reviewed basis.

3. Creative content providers may pay a fee for preferred privileges.

4. Clients or content providers may pay a one time or recurring membership fee.

5. Co-marketing and Branding relationships could be established between the various consumer product retailers and the main service website.

6. Retailers could offer products and or service to content providers and clients.

7. Resell of advertising directly within the main service website.

8. Advertisers could pay on a per user access or login basis.

9. Advertisers could pay on a per user access basis whereby users would be subjected to one or a multitude of advertisement(s) prior to being able to access their desired webpage.

10. Resell of advertising directly within the main service website.

11. Advertising space can be sold on the user specific web pages.

12. Opening the platform to other agencies in the future for a licensing fee or a per project fee.

Other methods of revenue generation may be incorporated into the use and function of the main website which is not referred to herein that do not alter the use, function, or application of the present invention, and are therefore to be considered apparent and obvious to the disclosure.

It is to be further understood that the present invention, while in the preferred embodiment is directed towards facilitating the submission, presentation, sale, purchase, development, & management of creative ideas, concepts, and or content related to video or movie content, may be utilized to perform the same functions and services disclosed herein in the preferred embodiment, for other types of media or creative content including but not limited in use to, photographers, writers, musicians, graphic artists, animators, etc.

Further the foregoing has outlined, in general, the physical aspects of the invention and is to serve as an aid to better understanding the intended use and application of the invention. The invention may be embodied by a computer program that is executed by a processor within a computer as a series of computer-executable instructions. The examples of encryption and decryption specifically point out preferred embodiments of the present invention, and are not to be construed as limiting in any way the remainder of the disclosure. Various user computers are connected to a plurality of web servers by means of the Internet. The web pages are maintained in the web servers and are downloaded to user computers by means of the Internet. Such examples are non-limiting in that one of ordinary skill (in view of the above) will readily envision other permutations and variations on the invention without departing from the principal concepts. Such permutations and variations are also within the scope of the present invention.

Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. An internet based method and process for facilitating the presentation, sale, purchase, development, & management of creative ideas, concepts, and or content namely, graphics, images, streaming media files, software, and other digital objects characterized in that the said internet based method and process comprises of computer software, including internet web page based code, and methods of applications for providing clients including creative content buyers and creative content providers with an interface for the said buyers looking for creative content and the said providers of creative content including but not limited in use to, video artists, photographers, writers, musicians, graphic artists and animators.

2. An internet based method and process as claimed in claim 1 wherein the said invention enables a website that the said content provider will access and enter log-in information in the form of a user name and or password or other secure login method.

3. An internet based method and process as claimed in claim 1 wherein the said invention enables a website that will allow the said creative content provider to post their creative idea, concept, or content after successful authentication of the login information entered.

4. An internet based method and process as claimed in claim 1 wherein the said invention enables a website that provides for a main website administrator who will interactively review and evaluate the said content submission, and accept or reject the said content submission and may give feedback, suggestions, or other assistance to the said creative content provider pertaining to the said content submission.

5. An internet based method and process as claimed in claim 1 wherein the said invention enables a website that allows the said creative content provider to easily login and check the status of one or a multitude of pending said content submissions and view the status of said content submissions, including but not limited in use to, “empty” (no idea submitted yet), “pending review”, “review with feedback”, “rejected” or “accepted”.

6. An internet based method and process as claimed in claim 1 wherein the said invention enables a website that includes one or a multitude of computer code based filters that will act to match the said creative content provider submissions with the said creative content buyer projects that have been submitted as content request submissions.

7. An internet based method and process as claimed in claim 1 and claim 6 wherein the said filters may utilize, keyword match, content match, content type, content buyer project code numbers or other project specific identifiers, or other idea, concept, or other content data or parameters that assist in matching said content provider submissions with said content buyer projects.

8. An internet based method and process as claimed in claim 1 wherein the said invention enables a website that provides an extensive database of creative ideas, concepts, and or content for the said content buyer to choose from.

9. An internet based method and process as claimed in claim 1 wherein the said invention enables a website that provides a database of said creative content providers that can be presented with or offered a project having specific criteria, guidelines, and or parameters in regards to appearance, design, function, and or content.

10. An internet based method and process as claimed in claim 1 wherein the said invention enables a website that the said content buyer will access and enter log-in information in the form of a user name and or password or other secure login method.

11. An internet based method and process as claimed in claim 1 wherein the said invention enables a website that will allow the said creative content buyer to utilize the website to perform a variety of functions or actions including but not limited in use to, input one or a multitude of new potential projects or content request submission into the database, manage existing potential projects or content request submissions, and or search through the database of submitted creative ideas, concepts, or content manually, after successful authentication of the login information entered.

12. An internet based method and process as claimed in claim 1 wherein the said invention enables a website application written in PHP, my SQL using AJAX or utilizing other platforms, systems, languages, or coding methods to create or make additions to the said main website.

13. An internet based method and process as claimed in claim 1 wherein the said invention enables a website whereby the said creative content provider that qualifies for a certain project has the opportunity to pitch his/her ideas with the creative idea development & management tool.

14. An internet based method and process as claimed in claim 1 wherein the said invention enables a website whereby the said creative content providers are provided a marketplace to shop their ideas, concepts, or content in a project specific or non project specific manner thus connecting them with the said creative content buyers who are seeking to purchase ideas, concepts, and or content for development and production.

15. An internet based method and process as claimed in claim 1 wherein the said invention enables a website whereby the said creative content providers are provided snapshots of all projects and their status on one single page and systematic way of receiving feedback /approval of submitted ideas.

16. An internet based method and process as claimed in claim 1 wherein the said invention enables a website whereby the said creative content buyers are provided access to a huge talent base of said creative content providers in a fully automated manner, thus being provided with novel cost effective creative content.

17. An internet based method and process as claimed in claim 1 wherein the said invention enables a website that allows the said creative content provider to earn revenue or monies on a per submission basis if the submission of selected for further development and or production.

18. An internet based method and process as claimed in claim 1 wherein the said invention enables a website that receives revenues or monies from said creative content buyers who hire or otherwise commission the said website to locate, match, or otherwise provide creative content for a specific project request submission.

19. An internet based method and process as claimed in claim 1 wherein the said invention enables a website that generates revenue from including but not limited to, per project basis fee, per submission reviewed basis project fee, preferred privileges fee, one time or recurring membership fee, Co-marketing and Branding relationships fee, fee from retailers who offer products and or services on said website, reselling of advertising, and per user access or login basis fee for advertisers.

20. An internet based method and process as claimed in claim 1 wherein the said invention enables a website for use by, including but not limited in use to, photographers, writers, musicians, graphic artists, animators, etc.
